(19) United States
(12) Patent Application Publication
(10) Pub. No.: US 2026/0291953 A1
(43) Pub. Date: Sep. 24, 2026

(54) PIPELINE FOR INTELLIGENTLY PRE-FILTERING CANDIDATES FOR MALICIOUS DOMAIN DETECTION

(71) Applicant: Palo Alto Networks, Inc., Santa Clara, CA (US)

(72) Inventors: Mohamed Yoosuf Mohamed Nabeel, San Jose, CA (US); Janos Szurdi, Budapest (HU); William Russell Melicher, Sunnyvale, CA (US); Ruian Duan, Fremont, CA (US); Oleksii Starov, Sunnyvale, CA (US); Daiping Liu, Santa Clara, CA (US)

(21) Appl. No.: 19/085,248

(22) Filed: Mar. 20, 2025

(51) Int. Cl. H04L 9/40

(52) U.S. Cl. CPC H04L 63/1416; H04L 63/0823

(57) ABSTRACT

A pipeline has been created to intelligently pre-filter candidates for malicious domain detection. While information from certificates allows for a “lightweight” feature set (e.g., less than 20 features from already collected data), the magnitude of domain certificates added to certificate transparency logs can be several million per day. The pipeline is designed to reduce this field of domains for evaluations from several million to approximately 1 million “newly observed certificate domains,” which are recently or newly certified domains. The pipeline determines whether a domain indicated in a certificate is a newly observed certificate domain based on evaluating information extracted from the certificate against criteria for determining whether the certificate has been newly/recently issued to the domain. Feature extraction for the lightweight feature set is then limited to the newly observed certificate domains for classifying by a machine learning model to identify suspicious domains.

### BACKGROUND

The disclosure generally relates to reducing malicious candidates for malicious domain detection (e.g., CPC subclass H04L 63/14).

The Certificate Transparency (CT) framework was developed in 2013 by Google® engineers for the logging of Transport Layer Security (TLS) certificates issued to website owners by Certificate Authorities. The CT framework was designed to protect against and monitor certificate misuse, allowing for certificates issued by Certificate Authorities to be publicly audited. Systems that implement the CT framework use CT logs to maintain records of certificates issued by various Certificate Authorities. CT logs are built using a Merkle Tree data structure which allows new certificates to be appended to the CT logs but prevents modification or deletion of the certificate logs.

### BRIEF DESCRIPTION OF THE DRAWINGS

Embodiments of the disclosure may be better understood by referencing the accompanying drawings.

FIG. 1 is a diagram of a pipeline for intelligently limiting malicious domain detection to newly observed certificate domains that the pipeline determined to be suspicious.

FIG. 2 is a diagram depicting an example architecture for a malicious domain classifier that classifies domains based on a feature set that includes the lightweight feature set and additional features for malicious domain detection.

FIG. 3 is a flowchart of example operations for intelligently limiting malicious domain detection to newly or recently certified domains.

FIG. 4 is a flowchart of example operations for classifying a newly or recently certified domain as suspicious or not-suspicious based on extracting features corresponding to a lightweight feature set.

FIG. 5 is a flowchart of example operations for classifying the suspicious domain as malicious or not malicious based on extracted features of a feature set that is larger than the lightweight feature set.

FIG. 6 depicts an example computer system with a malicious domain candidate filtering pipeline and a lightweight malicious domain classifier.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The description herein uses the term “lightweight” as a qualifier for a feature set and for a machine learning model (e.g., a neural network, support vector machine, or random forest model). A feature set is characterized as lightweight with respect to feature extraction efficiency. Usually, feature extraction from raw data is more expensive than machine learning inference in terms of time and computing resources. For the disclosed technology, a lightweight feature set is a feature set that can be extracted at a low processing cost, that allows for the ongoing feature extraction described herein. Accordingly, a lightweight machine learning model is a machine learning model configured for a lightweight feature set and trained on a lightweight feature set. In some cases, a lightweight feature set may be a subset of a larger feature set but does not need to be in order to be considered “lightweight”.

The description uses the term “continuously” in describing certain processing. To be described as continuous or ongoing, a process does not necessarily operate for an infinite time. A continuous or ongoing process can be interrupted and still be considered continuous. A continuous or ongoing process does not necessarily adhere to a periodic schedule.

As used in literature, this description uses the term “feature matrix” instead of feature vector because the term feature matrix includes a N×M matrix that allows for either or both of N and M to be greater than or equal to 1.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### INTRODUCTION

Conventional malicious domain detection systems process large numbers of domains per day. While inference time is not necessarily an impediment to processing a vast number of domains, feature extraction is expensive. Feature extraction is expensive, at least in terms of time, because these malicious domain detection systems typically extract at least 50 features to ensure accurate detection. For some of the features, raw data collection also contributes to the cost in terms of both time and computing resources. Due to the expense of feature extraction for accurate detection, including the raw data collection, the malicious domain detectors are generally run periodically. This results in a delay in the detection of whether a domain is malicious, which creates a window of opportunity for malicious actors to perform malicious activities (e.g., phishing, domain abuse, etc.) using the domain.

### Overview

A pipeline has been created to intelligently pre-filter candidates (and reduce corresponding cost) for malicious domain detection, thus facilitating more frequent or even ongoing malicious domain detection. While information from certificates allows for a “lightweight” feature set (e.g., less than 20 features from already collected data), the magnitude of domain certificates added to certificate transparency logs can be several million per day. The pipeline is designed to reduce this field of domains for evaluations from several million to approximately 1 million “newly observed certificate domains,” which are recently or newly certified domains. The pipeline determines whether a domain indicated in a certificate is a newly observed certificate domain based on evaluating information extracted from the certificate against criteria for determining whether the certificate has been newly/recently issued to the domain. Feature extraction for the lightweight feature set is then limited to the newly observed certificate domains and a machine learning model used to identify suspicious domains based on the extracted features. The identification of suspicious domains reduces the field of domains to be submitted for malicious domain detection from approximately 1 million to a few hundred thousand domains.

### Example Illustrations

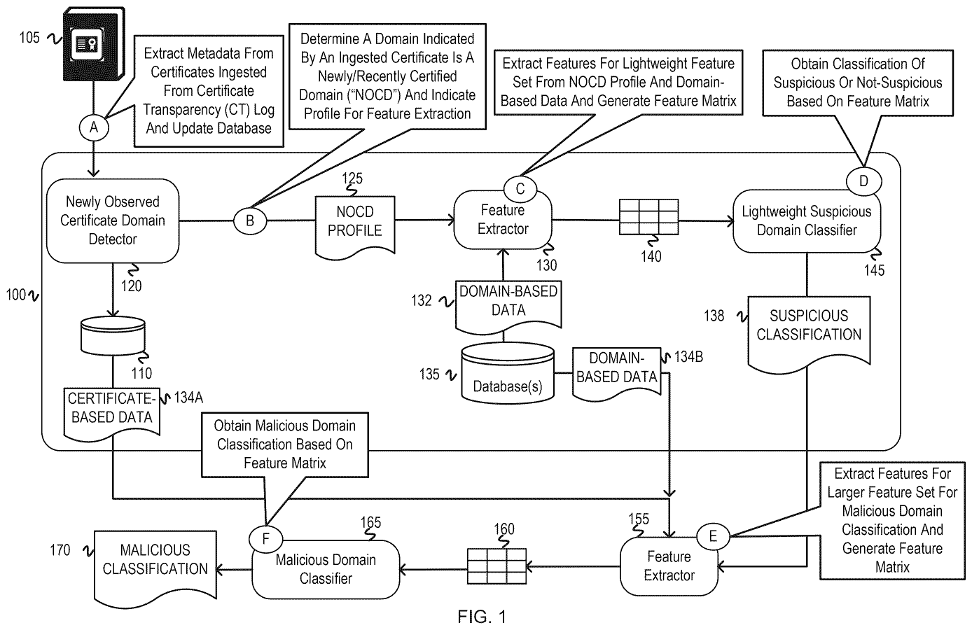

FIG. 1 is a diagram of a pipeline for intelligently limiting malicious domain detection to newly observed certificate domains that the pipeline determined to be suspicious. FIG. 1 depicts a malicious domain detection filtering pipeline 100 (henceforth “filtering pipeline”) that continuously evaluates domain certificates collected from a certificate transparency log(s) 105 to determine which domains should be submitted to a malicious domain classifier 165. This evaluation across certificates on a larger time scale (e.g., a day) for malicious domain detection can be considered filtering. However, the filtering pipeline 100 performs an ongoing evaluation of each collected certificate. The filtering pipeline 100 uses each collected certificate to identify suspicious domains (i.e., domains that may be malicious) which can then be analyzed by the malicious domain classifier 165.

FIG. 1 is annotated with a series of letters A-F representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the filtering pipeline 100 extracts metadata from certificates ingested from certificate transparency log(s) 105 and updates a database 110. The filtering pipeline 100 (or an ingest process of the filtering pipeline 100) can periodically query the CT log(s) 105 for new entries or subscribe to the CT log(s) 105 for new entries. In FIG. 1, a newly observed certificate domain (NOCD) detector 120 profiles each collected certificate and updates the database 110 based on the certificate profile. “Profiling” a certificate refers to extracting metadata from the certificate. In addition, the NOCD detector 120 evaluates each certificate profile to identify the domains that are NOCDs. In an implementation, the database 110 can index data stored therein by domain identifiers (e.g., a common domain name and/or domain Internet Protocol (IP) address) used to identify each domain. The NOCD detector 120 will either update an entry that exists in the database 110 or add a new entry to the database 110 depending on whether the domain indicated in a newly ingested certificate is already indicated in the database 110.

TABLE 1
below depicts example metadata extracted from a certificate.
Table 1: Example Certificate Profile

| Field | Value |
|---|---|
| Unique_ID | 3f2a8c19-7e4b-4d9b-b15e-92d3f8a6c4e7 |
| Scan_Time | 2023-08-12T08:15:00Z |
| Validity_Start | 2023-05-15T14:30:00Z |
| Validity_End | 2024-05-15T14:30:00Z |
| Common_Name | example.com |
| Subject_Alterative_Names | app1.example.com |
| Issuer | ExampleCA |
| Revocation_Lists | N/A |

The example certificate profile includes the fields “Validity_Start” and “Validity_End”. Based on the values of these fields, the NOCD detector 120 can determine when a certificate was issued. The certificate profile also includes a “Common Name” field which indicates a common name for a domain that has been certified, and the “Subject_Alternative_Names” (SAN) field which indicates alternative domain names, subdomain names, or Internet Protocol (IP) addresses for which the certificate is also valid. For example, the above certificate metadata indicates a primary domain “example.com” and an additional subdomain “app1.example.com”.

At stage B, the NOCD detector 120 determines that a domain indicated by an ingested certificate is a newly/recently certified domain (also referred to herein as NOCD) and then indicates the corresponding NOCD profile 125 for feature extraction. A domain can be determined to be a NOCD based on the “validity_start” date as described in reference to stage A. A parameter for a time boundary (e.g., last 6 months) can be configured or specified for determination of which domains are recently or newly certified. The NOCD detector 120 indicates the NOCD profile 125 for feature extraction by a feature extractor 130.

At stage C, the feature extractor 130 extracts features corresponding to a lightweight feature set from the NOCD profile 125 and from domain-based data 132 to generate a feature matrix 140. The feature extractor 130 retrieves, from a database(s) 135, the domain-based data 132 corresponding to a subset of the features in the lightweight feature set. Thus, the lightweight feature set extracted by the feature extractor 130 includes certificate-based features and domain-based features. Example certificate-based features include the issuing certificate authority (CA), the certificate validity period, and the number of SAN domains indicated in the certificate profile. Example domain-based features include lexical features of a common name of a NOCD, content category, and domain reputation. Example lexical features include the length of the common domain name, the number of hyphens, and the number of substrings in the common domain name. A domain reputation feature(s) can be based on reputation data obtained from internally maintained databases of reputation data and/or 3^{rd} party data sources of domain reputation data (e.g., Google Postmaster tools, the VirusTotal database, APIVoid, the Tranco list, etc.). Example reputation features include the domain's popularity ranking based on visitation traffic (e.g., Tranco ranking) and the domain's ownership. The feature extractor 130 generates the feature matrix 140 based on feature extraction of the lightweight feature set.

At stage D, a lightweight suspicious domain classifier 145 classifies as suspicious or not suspicious a domain represented by the feature matrix 140. The filtering pipeline invokes the lightweight suspicious domain classifier 145 on the feature matrix 140. The lightweight suspicious domain classifier 145 outputs a value that indicates a probability (e.g., a value between 0 and 1) of the domain represented by the feature matrix 140 being suspicious. The filtering pipeline 100 determines if the generated probability value satisfies a configured threshold X (e.g., X=0.7). If the output value is below the configured threshold, the lightweight suspicious domain classifier 145 classifies the corresponding domain as not suspicious and the filtering pipeline 100 filters out the domain from further malicious domain detection analysis. If the output value satisfies the configured threshold, the corresponding domain is classified as suspicious and is indicated to a second feature extractor 155. In FIG. 1, the domain represented by the feature matrix 140 has been classified as suspicious as indicated by a suspicious classification 138. An implementation can indicate the suspicious domain instead of the suspicious classification 138 to the feature extractor 155.

At stage E, the feature extractor 155 extracts features for a larger feature set than the lightweight feature set and generates a feature matrix 160. The larger feature set includes the lightweight feature set and additional domain-based features and certificate-based features. Examples of the additional domain-based features include hosting features (e.g., the number of IP addresses hosting the domain), WHOIS features (e.g., the domain's registration period), and scanning features (e.g., the number of services hosted by the domain). Example additional certificate-based features include historical certificate features (e.g., the number of certificates issued to the domain that expired). The feature extractor 155 retrieves from the database(s) 135 domain-based data 134B which corresponds to the additional domain-based features. In addition, the feature extractor 155 retrieves from the database 110 certificate-based data 134A, which corresponds to the additional certificate-based features. The feature extractor 155 generates the feature matrix 160 based on the feature matrix 140 and the values of the additional certificate-based features and the values of the additional domain-based features of the larger feature set. In some implementations, not all features of the lightweight feature set are included in the larger feature set. For example, the larger feature set for malicious domain detection can exclude the content category feature.

At stage F, the filtering pipeline 100 obtains a malicious domain classification 170 based on the feature matrix 160. The filtering pipeline 100 then invokes the malicious domain classifier 165 on the feature matrix 160. The filtering pipeline 100, based on output of the malicious domain classifier 165, determines the malicious domain classification 170.

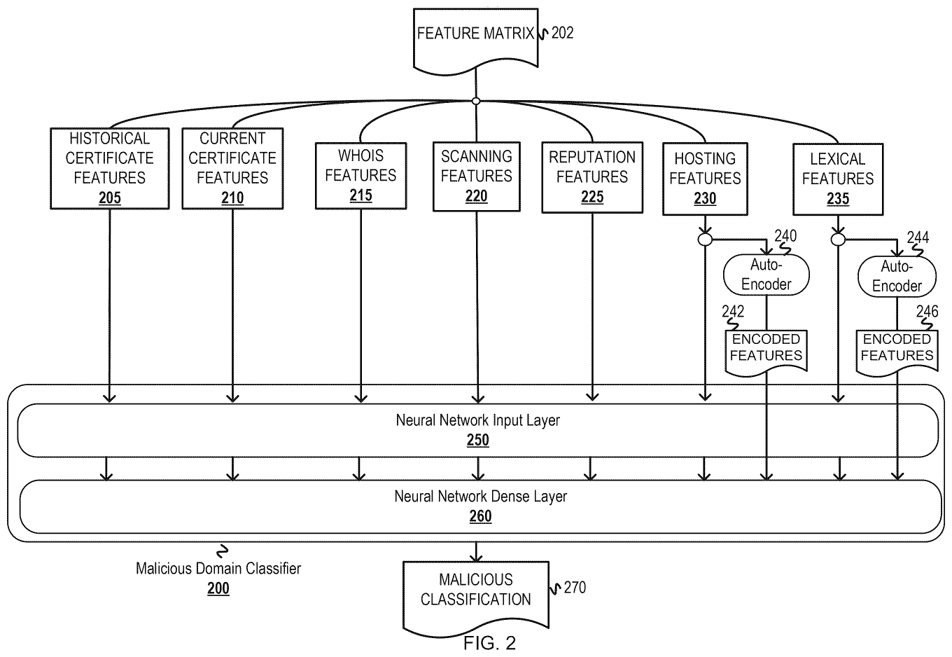

FIG. 2 is a diagram depicting an example architecture for a malicious domain classifier that classifies domains based on a feature set that includes the lightweight feature set and additional features for malicious domain detection. FIG. 2 depicts a feature matrix 202 which corresponds to a suspicious domain and which is input to a malicious domain classifier 200. The feature matrix 202 includes multiple features including certificate-based features and domain-based features that can appear in a larger feature set. The certificate-based features include historical certificate features 205 and current certificate features 210. The historical certificate features 205 correspond to features of certificates issued to the suspicious domain but have expired (or were revoked/invalidated when a re-issued certificate was issued to the suspicious domain). The current certificate features 210 correspond to the features of the certificate currently issued to the suspicious domain. The domain-based features depicted include WHOIS features 215, scanning features 220, reputation features 225, hosting features 230, and lexical features 235. The values extracted for those features are inputs to a neural network input layer 250 of a malicious domain classifier 200. The neural network input layer 250 can include an internal embedding layer (not depicted) to generate an embedding for each of the input features. FIG. 2 depicts a neural network dense layer 260 which receives the outputs of the neural network input layer 250.

The malicious domain classifier 200 includes autoencoders 240, 244 to respectively transform the values of the hosting features 230 and the values of the lexical features 235 into a more efficient representation for the malicious domain classifier 200 to process. The encoded feature values 242 for the hosting features 230 and the encoded feature values 246 for the lexical features 235 are already encoded and therefore are input directly into the neural network dense layer 260. Although the example in FIG. 2 only depicts autoencoders that are encoding hosting features 230 and lexical features 235, more or fewer features of a larger feature set in practice could be subject to auto-encoding based on the architecture of the malicious domain classifier 200. The malicious domain classifier 200 generates a malicious classification 270 for the suspicious domain based on the raw and encoded features. Embodiments are not limited to using autoencoders for generating efficient representations of feature values. For instance, a transformer-based model (e.g., Bi-directional Encoder Representations from Transformers (BERT) model) could be used.

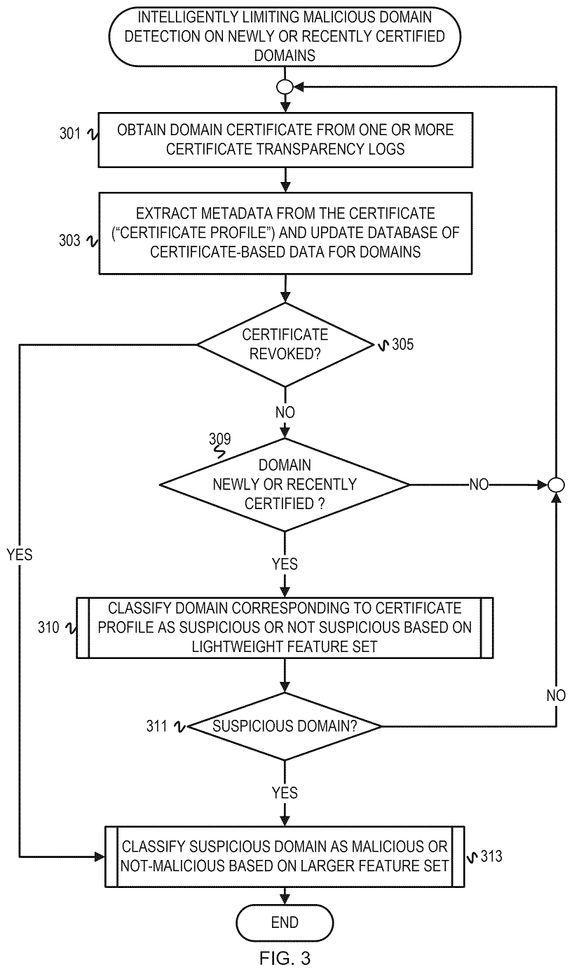

FIGS. 3-5 are example flowcharts for intelligently limiting malicious domain detection on newly or recently certified domains determined to be suspicious. The example operations are described with reference to a filtering pipeline for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for intelligently limiting malicious domain detection to newly or recently certified domains. Although the pipeline performs the ongoing evaluation of each certificate collected, FIG. 3 will describe the operations performed on an individual certificate. The way the filtering pipeline organizes its modules to carry out the operations described below can vary based on the filtering pipeline's implementation.

At block 301, the filtering pipeline obtains a domain certificate from one or more certificate transparency (CT) logs. The filtering pipeline can subscribe to or poll one or more CT logs for new entries. In some implementations, the filtering pipeline can utilize software-based tools to fetch entries from CT logs. Example tools include ScanLog, CTClone, etc. In other implementations, the filtering pipeline can utilize a 3^{rd} party service (e.g., the CertStream service, the Censys® Search service) by making an API call to the service which then retrieves CT log entries and relays them to the filtering pipeline.

At block 303, the filtering pipeline extracts metadata from an obtained certificate and updates a database of certificate-based data for domains. The filtering pipeline can extract all or a subset of metadata from a certificate to create a certificate profile. Examples of extracted metadata include the certificate's unique identifier, the certificates validity start and end dates, the issuer of the certificate, the common name of the domain indicated by the certificate, the subject alternative names (SANs) the certificate is valid for, and any certificate revocation lists which reference the certificate. Based on whether there is an existing entry in the database of certificate-based data for the domain indicated in the obtained certificate, the filtering pipeline updates an existing entry or adds a new entry to the database of certificate-based data (henceforth “certified domains database”).

At block 305, the filtering pipeline determines if the certificate corresponding to the certificate profile is revoked. The filtering pipeline checks if the corresponding certificate profile indicates one or more revocation lists in which the corresponding certificate is referenced. If the certificate corresponding to the certificate profile is referenced in one or more revocation lists (i.e., the certificate has been revoked), then the corresponding domain is treated as suspicious and a candidate for malicious domain detection. If the certificate corresponding to the certificate profile is revoked, then operational flow continues at block 313. If the certificate corresponding to the certificate profile is not revoked, then operational flow continues at block 309.

At block 309, the filtering pipeline determines if the domain corresponding to the certificate profile is newly or recently certified. A newly certified domain refers to a domain which was issued a certificate for the first time. A recently certified domain refers to a domain which had already been issued certificates in the past but, either through a renewal or a re-issue by a certificate authority, the domain was issued a new certificate. In either case, a time boundary is defined to separate newly or recently certified domains from those that were certified too long ago (i.e., beyond the time boundary) to be considered newly or recently certified. The time boundary can be a configurable parameter (e.g., last 6 months) to determine which domains are newly or recently certified domains. If the corresponding domain is determined to be newly or recently certified, then operational flow continues at block 310. Otherwise, operational flow returns to block 301.

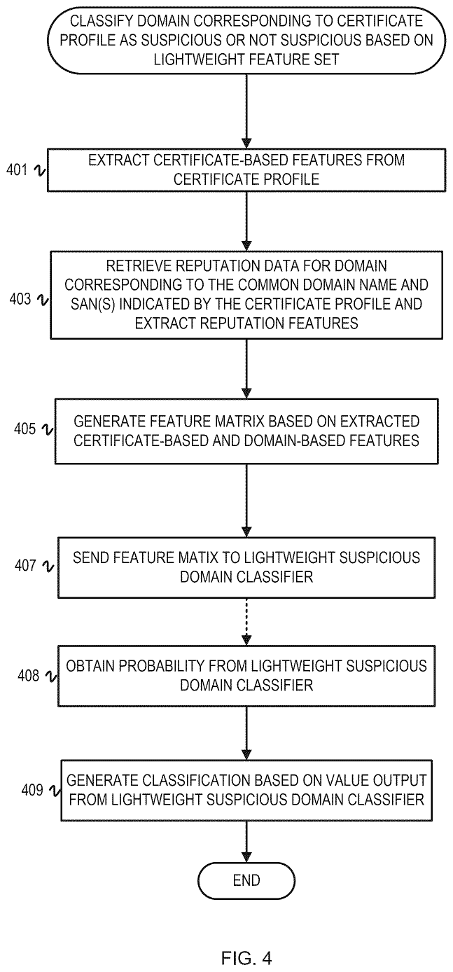

At block 310, the filtering pipeline classifies the domain corresponding to the certificate profile as suspicious or not suspicious based on a lightweight feature set. This operation is further described in FIG. 4.

At block 311, the filtering pipeline determines if the corresponding domain is suspicious. The filtering pipeline compares the generated classification against a criterion for suspiciousness, such as a threshold probability, to determine whether the domain is suspicious or not suspicious. If the corresponding domain is suspicious, then operational flow continues at block 313. Otherwise, operational flow returns to block 301.

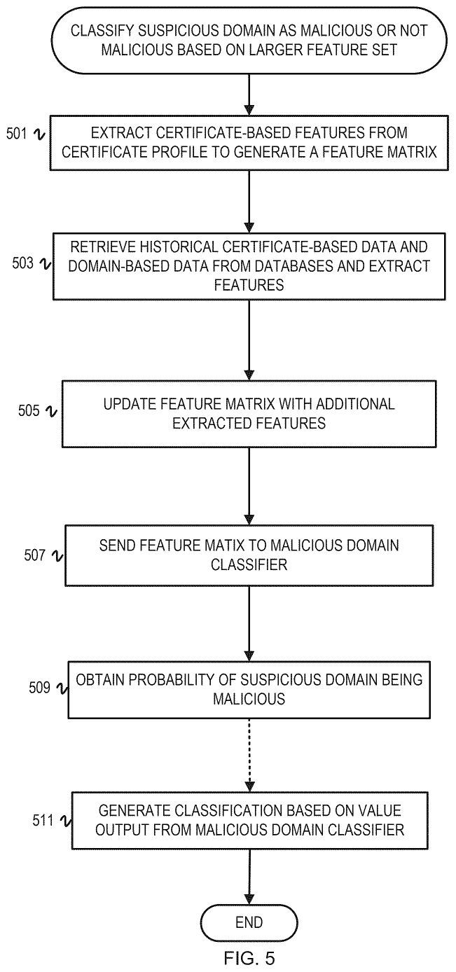

At block 313, the filtering pipeline classifies the suspicious domain as malicious or not-malicious based on a larger feature set. Based on the obtained malicious or non-malicious classification, the filtering pipeline may perform a security action and/or generate notifications based on a malicious classification. The operations for this block are further described in FIG. 5.

FIG. 4 is a flowchart of example operations for classifying a newly or recently certified domain as suspicious or not-suspicious based on extracting features corresponding to a lightweight feature set. The operations of FIG. 4 presume that a certificate profile corresponding to a newly or recently certified domain has been indicated for suspicious domain detection to a lightweight suspicious domain classifier. As previously described, a lightweight feature set can include certificate-based features and domain-based features.

At block 401, the filtering pipeline extracts certificate-based features from the certificate profile. Certificate-based features include features extracted directly from the certificate profile, including lexical features of the common domain name and extracts lexical features of each SAN indicated in the certificate profile for the domain. While embodiments can use the values of the lexical features of each SAN, embodiments can also aggregate the values of the features of the SANs. For example, pooling (e.g., max pooling, average pooling) can be used to reduce dimensionality or downsample the lexical features extracted for the SANs, assuming more than one SAN is present in the certificate profile. The filtering pipeline can be configured to extract a subset of metadata from the certificate profile which corresponds to the features of the lightweight feature set. To extract the metadata, the filtering pipeline can parse the certificate profile to identify fields in the certificate profile which correspond to the features of the lightweight feature set and extract the matching metadata.

At block 403, the filtering pipeline retrieves reputation data for the domain(s) corresponding to the common domain name and SANs indicated by the certificate profile, and extracts reputation features. The reputation data retrieved by the filtering pipeline corresponds to the domain-based features of the lightweight feature set. To obtain the domain reputation data, the filtering pipeline queries internal or 3rd party data sources which maintain reputation data for domains. For example, the filtering pipeline can query a domain reputation database and retrieve data (e.g., reputation scores) corresponding to the common domain name and each SAN indicated in the certificate profile. Similar to the lexical features of SANs, the values of the reputation feature for the SANs can be aggregated. In some implementations, the filtering pipeline may make an application programming interface (API) call to one or more 3rd party data sources of domain reputation data to retrieve reputation data corresponding to the domain-based features of the lightweight feature set. The reputation data corresponding to the domain-based features retrieved in this operation and the certificate-based features extracted in block 401 together represent the lightweight feature set.

At block 405, the filtering pipeline generates a feature matrix based on the extracted certificate-based and domain-based features (i.e., the lightweight feature set). For instance, the filtering pipeline invokes a function defined by a machine learning model library to generate the feature matrix from the extracted features. Before generating the feature matrix, the filtering pipeline may preprocess some of the extracted values or the feature extraction can include some preprocessing. To illustrate, the filtering pipeline can use a technique such as one-hot encoding to convert categorical feature values (e.g., the certificate's issuer). For example, if a certificate-based feature corresponding to the certificate issuer has three categories: “CA1”, “CA2”, and “CA3” for the possible CAs, then a resulting array for that feature could be [1,0,0], where each value corresponds to a different CA. In some cases, the filtering pipeline may also normalize values of at least some features of the lightweight feature when preprocessing raw feature values. Implementations can pre-process the values of the lightweight feature set to normalize and/or scale values. For example, passive DNS query count and passive DNS duration can be logarithm normalized. In addition, the feature matrix can be scaled using a min-max scaler.

At block 407, the filtering pipeline sends the feature matrix to the lightweight suspicious domain classifier. If the lightweight suspicious domain classifier is external to the filtering pipeline, the filtering pipeline can make an API call to invoke the model to output a probability that can be used to classify the domain as suspicious or not suspicious. If the model is internal to the pipeline, the filtering pipeline can invoke the model by calling a pre-defined function of the pipeline.

At block 408, the filtering pipeline obtains the probability from the lightweight suspicious domain classifier. In cases where the probability isn't already normalized, the filtering pipeline itself can normalize the probability to a value that can be used to classify the domain indicated by the certificate profile. The dashed line between blocks 407 and 408 indicates the filtering pipeline waits for a response from the lightweight suspicious domain classifier before proceeding to the operations of block 409.

At block 409, the filtering pipeline generates a classification based on the value output from the lightweight suspicious domain classifier. As previously described, the filtering pipeline can compare the obtained probability value to a threshold to determine if the corresponding domain is suspicious or not. In implementations where the output probability value is not normalized, the filtering pipeline may indicate the un-normalized probability to another machine learning model which is trained to interpret un-normalized probabilities and generate a suspicious classification. The filtering pipeline then uses the classification generated by the machine learning model.

FIG. 5 is a flowchart of example operations for classifying the suspicious domain as malicious or not malicious based on extracted features of a feature set that is larger than the lightweight feature set. The operations of FIG. 5 presume that a newly or recently certified domain has been classified as suspicious, and the corresponding certificate profile has been indicated to (or has been retrieved by) the malicious domain classifier. The operations of FIG. 5 also presume a feature matrix which includes features of the lightweight feature set has been previously generated.

At block 501, the filtering pipeline extracts certificate-based features from the certificate profile. Certificate-based features of the larger set include the certificate-based features of the lightweight feature set (or a subset of them) and additional certificate-based features which are used for malicious domain detection. The filtering pipeline parses the certificate profile to identify and extract metadata from the certificate profile which was not previously extracted during the operations described in reference to block 401.

At block 503, the filtering pipeline retrieves historical certificate-based data and domain-based data from databases and extracts the features to generate a feature matrix for malicious domain detection. The filtering pipeline can query or make an API call to one or more 3^{rd} party sources of domain-based data to retrieve the relevant domain-based data corresponding to the additional domain-based features of the larger feature set. The filtering pipeline can query different databases depending on the type of domain-based feature being extracted. For example, the filtering pipeline can query a database of domain reputation data corresponding to domain reputation features or can query databases of domain name system (DNS) data to obtain data corresponding to domain hosting or query attack surface management data to retrieve raw data corresponding to scanning features. To obtain the historical certificate-based data, the filtering pipeline can perform a lookup in the certified domains database using the common name of the suspicious domain. The filtering pipeline then retrieves the historical certificate profiles based on the lookup results and extracts features from the historical certificate profiles which correspond to the additional certificate-based features.

In some implementations, for some features of the larger feature set, the filtering pipeline only retrieves the most recent data observation from the corresponding database (e.g., when data corresponds to a feature that is not expected to change between observations such as a certificate's issuer). For features which have values that may fluctuate, the filtering pipeline can retrieve the last observation for the features and additional historical observations within a configured time boundary. The filtering pipeline can configure the time boundary to determine which historical database entries the filtering pipeline retrieves. For example, the filtering pipeline may be configured to retrieve all observations of domain reputation scores in the last 30 days since reputation scores may fluctuate. Although blocks 501 and 503 are depicted to be performed sequentially, in practice they can be performed in parallel or concurrently.

At block 505, the filtering pipeline updates the feature matrix with the additional extracted features. For each additional feature, the filtering pipeline updates the feature matrix with an additional column corresponding to the additional feature. Similar to the operations of block 405, the filtering pipeline converts categorical features into a numerical representation before updating the feature matrix. For features with multiple observations, the filtering pipeline can update the feature matrix with a new row (or fill an entry in a row if the row has already been created) for each observation and update the corresponding entry with the data for each observation. As with the lightweight feature matrix, the filtering pipeline can pre-process the values of the malicious domain detection feature matrix to normalize and/or scale values.

In the example described above, a feature matrix derived from the lightweight feature set is updated by appending an additional column(s) or row(s) for each additional feature. In some implementations, the filtering pipeline may generate separate feature matrices for the lightweight feature set and the additional features and concatenate them to generate a combined feature matrix. The filtering pipeline then populates the blank matrix with the corresponding feature values for the lightweight feature set as well as the additional features of the larger feature set.

At block 507, the filtering pipeline indicates the feature matrix to the malicious domain classifier. In cases where the malicious domain classifier is external to the filtering pipeline and exposes an API, the filtering pipeline can make an API call to invoke the malicious domain classifier on the feature matrix. If the malicious domain classifier is implemented as an internal module of the pipeline, the filtering pipeline can call a pre-defined function to invoke the model on the feature matrix.

At block 509, the filtering pipeline obtains a probability of the suspicious domain being malicious. The probability obtained from the malicious domain classifier can be either normalized or not normalized based on the architecture of the malicious domain classifier. In cases where the malicious domain classifier uses an activation function to normalize the output of the model, then the output probability could be between a standardized range (e.g., a value between 0 and 1). In cases where the output probability is not normalized, the filtering pipeline may perform its own normalization to convert the output probability to a value which can be used to classify the suspicious domain.

At block 511, the filtering pipeline classifies the suspicious domain as malicious or not malicious based on the probability output from the malicious domain classifier. A classification of maliciousness can be obtained in the same manner as the classification of suspiciousness as described in reference to block 409.

### VARIATIONS

For ease of explanation, the example illustrations described operations for certificates ingested by the filtering pipeline that correspond to single-domain certificates (i.e., the common domain name and SANs indicated in the certificate correspond to the same domain). In some cases, a certificate can be issued for multiple domains (“multi-domain certificate”). In the case of a multi-domain certificate common name and at least some of the SANs indicated in the certificate correspond to more than one domain. To determine whether a certificate is a multi-domain certificate, the domain names are evaluated to determine whether the SAN field indicates more than subdomains corresponding to the common name. If it is determined that a multi-domain certificate is ingested, each domain is individually processed. To illustrate, a certificate may indicate a common name “www.example1.com” and SANs “first.example1.com, second.example1.com, www.example2.com, www.example1.net, another.example1.net, another.example2.net.” The domain names would be separated based on their registered domains (i.e., effective second level domains or public suffix domains) as follows: example1.com, example1.net, example2.net, and example2.com. A certificate profiles would be created for each of the registered domains. The NOCD determination would be performed for each of example.com, example1.net, example2.net, and example2.com. Assuming only example2.com is filtered out as not NOCD, suspicious classification would be performed for the 3 remaining registered domains. For instance, a lightweight feature matrix would be generated based on example1.com with aggregation of the lightweight features for all the SANs indicated in the certificate profile for the registered domain. Assuming the domain represented by example.com is classified as suspicious, malicious domain detection would be performed for example1.com.

The example operations above described a case in which the lightweight suspicious domain classifier and the malicious domain classifier are each a binary classifier. In some cases, either or both of the lightweight suspicious domain classifier and the malicious domain classifier may be a multi-class classifier. For example, instead of classifying a suspicious domain as being either malicious or not malicious, the malicious domain classifier can instead generate logits or a probability distribution for the classes of malicious and benign. If both classifications are below a confidence threshold, then the corresponding domain can be classified as unknown.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 501 and 503 can be performed in parallel or concurrently. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

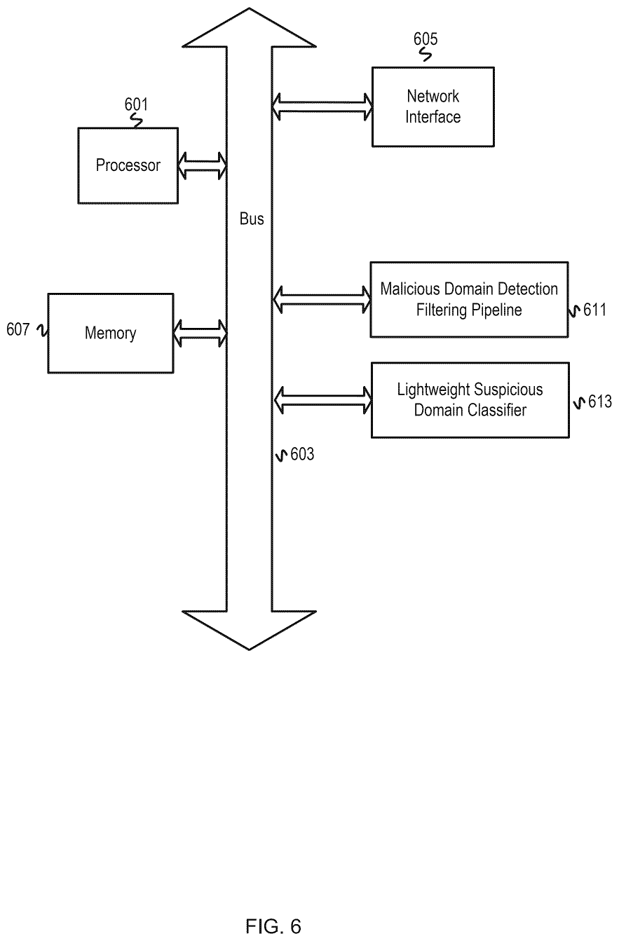

FIG. 6 depicts an example computer system with a malicious domain candidate filtering pipeline and a lightweight malicious domain classifier. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes the malicious domain detection filtering pipeline (“filtering pipeline”) 611 and a lightweight suspicious domain classifier 613. The filtering pipeline 611 continuously obtains domain certificates and extracts metadata from those certificates to generate certificate profiles. The filtering pipeline 611 determines if domains indicated by the certificates are newly or recently certified domains by analyzing the metadata of their corresponding certificate profile. Features are extracted from the certificate profiles of the domains that are determined to be newly or recently certified as well as domain-based data for those domains. The lightweight suspicious domain classifier 613 classifies the domain as suspicious or not suspicious based on the extracted features. The filtering pipeline 611 then indicates suspicious domains to a malicious domain classifier for malicious domain detection. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
continuously obtaining domain certificates from one or more certificate transparency logs;
for each domain certificate,
determining whether a domain indicated by the domain certificate has been issued a certificate within a preceding time boundary;
based on determining that the domain has not been issued a previous certificate within the preceding time boundary, extracting a first set of features that comprise certificate features of the domain certificate and lexical features of the domain to create a first feature matrix;
invoking a first machine learning model on the first feature matrix, wherein the first machine learning model has been trained to classify domains as suspicious;
determining whether the domain is suspicious based on a classification by the first machine learning model; and
determining whether to invoke a second machine learning model for malicious domain detection based on determining whether the domain indicated by the domain certificate is suspicious.

2. The method of claim 1 further comprising updating a database of domain certificate information for each obtained domain certificate, wherein updating the database comprises updating the database with data extracted from the domain certificate and wherein determining whether a domain indicated by the domain certificate has been issued a previous certificate within the preceding time boundary comprises determining whether the database indicates a previous certificate issued outside of the preceding time boundary which also indicates the domain.

3. The method of claim 1, wherein the first set of features also comprises reputation of the domain and content category corresponding to the domain.

4. The method of claim 1 further comprising:
based on determining that the domain is suspicious,
extracting a second set of features to form a second feature matrix, wherein the second set of features comprises the first set of features and features corresponding to domain registration data, security posture data of network addresses of the domain, hosting information, and historical certificate information; and
invoking the second machine learning model on the second feature matrix for malicious domain detection.

5. The method of claim 4 further comprising updating a database of domain certificate information for each obtained domain certificate, wherein updating the database comprises updating with data extracted from the domain certificate and wherein extracting those of the features corresponding to historical certificate information comprises retrieving the historical certificate information for the domain from the database.

6. The method of claim 1 further comprising determining whether a domain indicated in an obtained domain certificate is indicated in a certificate revocation list, wherein extracting the first set of features is also based on determining that the domain is not indicated in a certificate revocation list.

7. The method of claim 6 further comprising indicating the domain as likely malicious based on determining that the domain is indicated in the certificate revocation list.

8. A non-transitory, machine-readable medium having program code stored thereon, the program code comprising instructions to:
continuously obtain domain certificates from one or more certificate transparency logs;
for each domain certificate,
determine whether a domain indicated by the domain certificate has been issued a certificate within a preceding time boundary;
based on determining that the domain has not been issued a certificate within the preceding time boundary, extract a first set of features that comprise certificate features of the domain certificate and lexical features of the domain to create a first feature matrix;
invoke a first machine learning model on the first feature matrix, wherein the first machine learning model has been trained to classify domains as suspicious;
determine whether the domain is suspicious based on a classification by the first machine learning model; and
determine whether to invoke a second machine learning model for malicious domain detection based on determining whether the domain indicated by the domain certificate is suspicious, wherein the first machine learning model is lightweight with respect to the second machine learning model.

9. The non-transitory, machine-readable media of claim 8, wherein the program code further comprises instructions to update a database of domain certificate information for each obtained domain certificate, wherein instructions to update the database comprises instructions to update the database with data extracted from the domain certificate and wherein instructions to determine whether a domain indicated by the domain certificate has been issued a previous certificate within the preceding time boundary comprises instructions to determine whether the database indicates a previous certificate issued outside of the preceding time boundary which also indicates the domain.

10. The non-transitory, machine-readable media of claim 8, wherein the first set of features also comprises reputation of the domain and content category corresponding to the domain.

11. The non-transitory, machine-readable media of claim 8, wherein the program code further comprises instructions to:
based on a determination that the domain is suspicious,
extract a second set of features to form a second feature matrix, wherein the second set of features comprises the first set of features and features corresponding to domain registration data, security posture data of network addresses of the domain, hosting information, and historical certificate information; and
invoke the second machine learning model on the second feature matrix for malicious domain detection.

12. The non-transitory, machine-readable media of claim 11, wherein the program code further comprises instructions to update a database of domain certificate information for each obtained domain certificate, wherein instructions to update the database comprises instructions to update with data extracted from the domain certificate and wherein instructions to extract those of the features corresponding to historical certificate information comprises instructions to retrieve the historical certificate information for the domain from the database.

13. The non-transitory, machine-readable media of claim 8, wherein the program code further comprises instructions to determine whether a domain indicated in an obtained domain certificate is indicated in a certificate revocation list, wherein instructions to extract the first set of features are also based on a determination that the domain is not indicated in a certificate revocation list.

14. The non-transitory, machine-readable media of claim 13, wherein the program code further comprises instructions to indicate the domain as likely malicious based on a determination that the domain is indicated in the certificate revocation list.

15. An apparatus comprising:
a processor; and
a machine-readable medium having instructions stored thereon that are executable by the processor to cause the apparatus to,
determine whether a domain indicated by a first certificate has been issued a previous certificate within a preceding time boundary;
based on instructions that are executable by the processor to cause the apparatus to determine that the domain has not been issued a certificate within the preceding time boundary, extract a first set of features that comprise certificate features of the first certificate and lexical features of the domain to create a first feature matrix;
invoke a first machine learning model on the first feature matrix, wherein the first machine learning model has been trained to classify domains as suspicious;
determine whether the domain is suspicious based on a classification by the first machine learning model; and
determine whether to invoke a second machine learning model for malicious domain detection based on determining whether the domain indicated by the first certificate is suspicious, wherein the first machine learning model is lightweight with respect to the second machine learning model.

16. The apparatus of claim 15, wherein the machine-readable medium further has stored thereon instructions executable by the processor to cause the apparatus to update a database of domain certificate information for each obtained domain certificate, wherein instructions to update the database further comprises instructions executable by the processor to cause the apparatus to update the database with data extracted from the first certificate and wherein instructions to determine whether a domain indicated by the first certificate has been issued a certificate within the preceding time boundary further comprises instructions executable by the processor to cause the apparatus to determine whether the database indicates a previous domain certificate issued outside of the preceding time boundary which also indicates the domain.

17. The apparatus of claim 15, wherein the machine-readable medium further has stored thereon instructions executable by the processor to cause the apparatus to, based on a determination that the domain is suspicious,
extract a second set of features to form a second feature matrix, wherein the second set of features comprises the first set of features and features corresponding to domain registration data, security posture data of network addresses of the domain, hosting information, and historical certificate information; and
invoke the second machine learning model on the second feature matrix for malicious domain detection.

18. The apparatus of claim 17, wherein the machine-readable medium further has stored thereon instructions executable by the processor to cause the apparatus to update a database of domain certificate information for each obtained domain certificate, wherein instructions to update the database further comprises instructions executable by the processor to cause the apparatus to update the database with data extracted from the first certificate and wherein instructions to extract those of the features corresponding to historical certificate information further comprises instructions executable by the processor to cause the apparatus to retrieve the historical certificate information for the domain from the database.

19. The apparatus of claim 15, wherein the machine-readable medium further has stored thereon instructions executable by the processor to cause the apparatus to determine whether a domain indicated in an obtained domain certificate is indicated in a certificate revocation list, wherein instructions executable by the processor to cause the apparatus to extract the first set of features is also based on a determination that the domain is not indicated in a certificate revocation list.

20. The apparatus of claim 19, wherein the machine-readable medium further has stored thereon instructions executable by the processor to cause the apparatus to indicate the domain as likely malicious based on a determination that the domain is indicated in the certificate revocation list.
